(19) United States
(12) Patent Application Publication
(10) Pub. No.: US 2026/0359964 A1
(43) Pub. Date: Nov. 12, 2026

(54) METHOD FOR EVALUATING CRACK ON EMBANKMENT

(71) Applicant: TIANJIN UNIVERSITY, Tianjin (CN)

(72) Inventors: Boyang XIA, Tianjin (CN); Haizuo Zhou, Tianjin (CN); Gang Zheng, Tianjin (CN)

(21) Appl. No.: 19/468,941

(22) Filed: Feb. 3, 2026

(30) Foreign Application Priority Data
May 12, 2025 (CN) 202510600449.X

(51) Int. Cl. G06T 7/00; G06V 10/80

(52) U.S. Cl. CPC G06T 7/0004; G06V 10/806; G06T 2207/20081

(57) ABSTRACT

A method for evaluating a crack on an embankment, which may be applied to a technical field of geotechnical engineering, includes: acquiring initial to-be-evaluated information corresponding to the crack on a surface of the embankment; processing the initial to-be-evaluated information based on a decomposition strategy and a preset threshold to obtain to-be-evaluated information, where the to-be-evaluated information includes geometric information of the embankment, soil information of the embankment, and environmental information corresponding to the embankment, and where the initial to-be-evaluated information is decomposed using the decomposition strategy, and the decomposed initial to-be-evaluated information is threshold-quantized using the preset threshold; and inputting the soil information, the geometric information, and the environmental information into an evaluation model to obtain a size evaluation result of the crack and a rate evaluation result of the crack, where the evaluation model includes a feature evaluation sub-model and a state evaluation sub-model.

### CROSS REFERENCE TO RELATED APPLICATION(S)

This application claims the benefit of priority to Chinese Patent Application No. 202510600449.X, filed on May 12, 2025. The entire contents of this application are hereby incorporated herein by reference.

### TECHNICAL FIELD

The present disclosure relates to a technical field of geotechnical engineering, and in particular to a method for evaluating a crack on an embankment.

### BACKGROUND

A crack on an embankment may cause various problems. For example, in the aspect of road structure, the crack may weaken the overall strength of a subgrade and a pavement, leading to reduced pavement bearing capacity and accelerated damage to a pavement structure; at the traffic safety level, the crack may reduce pavement flatness, affecting the comfort and stability of vehicle operation; the crack may provide an infiltration channel for rain, snow, etc., aggravating the softening and erosion of subgrade soil, and increasing road maintenance costs and repair difficulties. The prediction and simulation methods for the crack on the embankment in the related art mainly include: simulating stress distribution and deformation conditions of the embankment under different conditions through a finite element method to predict the location of the crack and the expansion trend of the crack; analyzing and segmenting a crack image based on a deep learning network (such as Transformer) to predict the location of the crack and the shape of the crack in a future time period; and real-time monitoring the state of the surface of the road by installing a sensor (such as a strain gauge, a displacement meter) on the embankment.

### SUMMARY

The present disclosure provides a method for evaluating a crack on an embankment, a device, and a medium.

According to an aspect of the present disclosure, a method for evaluating a crack on an embankment is provided, including: acquiring initial to-be-evaluated information corresponding to the crack on a surface of the embankment; processing the initial to-be-evaluated information based on a decomposition strategy and a preset threshold to obtain to-be-evaluated information, where the to-be-evaluated information includes geometric information of the embankment, soil information of the embankment, and environmental information corresponding to the embankment, and where the initial to-be-evaluated information is decomposed using the decomposition strategy, and the decomposed initial to-be-evaluated information is threshold-quantized using the preset threshold; and inputting the soil information, the geometric information, and the environmental information into an evaluation model to obtain a size evaluation result of the crack and a rate evaluation result of the crack, where the evaluation model includes a feature evaluation sub-model and a state evaluation sub-model.

Another aspect of the present disclosure provides an electronic device, including: one or more processors; and a memory for storing one or more computer programs, where the one or more processors execute the one or more computer programs to implement the steps of the above method.

Another aspect of the present disclosure further provides a non-transitory computer-readable storage medium having a computer program or instructions therein, where the computer program or instructions, when executed by a processor, is used to implement the steps of the above method.

### BRIEF DESCRIPTION OF THE DRAWINGS

The above contents and other objectives, features and advantages of the present disclosure will be more clear through the following description of embodiments of the present disclosure with reference to the accompanying drawings, wherein:

FIG. 1 shows an application scenario diagram of a method for evaluating a crack on an embankment, an apparatus for evaluating a crack on an embankment, a device, a medium, and a program product according to an embodiment of the present disclosure;

FIG. 2 shows a flowchart of a method for evaluating a crack on an embankment according to an embodiment of the present disclosure;

FIG. 3A shows an exemplary schematic diagram of a training process of an initial evaluation model according to an embodiment of the present disclosure;

FIG. 3B shows a schematic structural diagram of a CNN layer according to an embodiment of the present disclosure;

FIG. 3C shows a schematic structural diagram of a BiLSTM layer according to an embodiment of the present disclosure;

FIG. 4A shows a three-dimensional schematic diagram of a longitudinal crack in a widened embankment according to an embodiment of the present disclosure;

FIG. 4B shows a comparison diagram of a measured value of a crack width of a widened embankment and a predicted value of the crack width of the widened embankment according to an embodiment of the present disclosure;

FIG. 5 shows a structural block diagram of an apparatus for evaluating a crack on an embankment according to an embodiment of the present disclosure; and

FIG. 6 shows a block diagram of an electronic device suitable for implementing a method for evaluating a crack on an embankment according to an embodiment of the present disclosure.

### DETAILED DESCRIPTION OF EMBODIMENTS

Embodiments of the present disclosure will be described below with reference to the accompanying drawings. It should be understood, however, that these descriptions are merely exemplary and are not intended to limit the scope of the present disclosure. In the following detailed descriptions, for purposes of explanation, numerous specific details are set forth in order to provide a thorough understanding of embodiments of the present disclosure. It is clear, however, that one or more embodiments may be implemented without these specific details. In addition, in the following descriptions, descriptions of well-known structures and technologies are omitted to avoid unnecessarily obscuring the concept of the present disclosure.

Terms used herein are for the purpose of describing embodiments only and are not intended to limit the present disclosure. Terms “comprising”, “including” and the like used herein specify a presence of the feature, step, operation and/or component, but do not preclude a presence or addition of one or more other features, steps, operations or components.

All terms (including technical and scientific terms) used herein have the meaning as commonly understood by those skilled in the art, unless otherwise defined. It should be noted that the terms used herein should be construed to have meanings consistent with the context of the present description and should not be construed in an idealized or overly rigid manner.

Where expressions like “at least one of A, B, or C, etc.” are used, they should generally be interpreted in accordance with the meaning of the expression as commonly understood by those skilled in the art (e.g., “a system having at least one of A, B or C” should include, but not be limited to, a system having A alone, having B alone, having C alone, having A and B, having A and C, having B and C, and/or having A, B, and C, etc.).

In the related art, a numerical simulation method requires the construction of a relatively accurate mathematical model, and the accuracy of a simulation result depends on the precision of an input parameter; an existing deep learning model lacks appropriate preprocessing for multi-source measurement data in a prediction process, and the measurement data are mostly non-stationary signals, resulting in the loss of a key feature and the low accuracy of a prediction result. The method of real-time monitoring using a device is significantly affected by an external environmental factor (e.g., temperature, humidity) and involves high device costs.

The present disclosure may retain a key feature of initial to-be-evaluated information through to-be-evaluated information processed by a decomposition strategy and a preset threshold, improving the signal-to-noise ratio and quality of data. As an evaluation model integrates multi-source information and time-series information, enabling the feature evaluation function and state evaluation function, and the long-term trend is captured by extracting the key feature of the multi-source information, the processing of the nonlinear time-varying characteristic of the crack on the embankment is achieved, the size evaluation result of the crack and the rate evaluation result of the crack at a future moment are further obtained, the rationality and reliability of crack evaluation are improved.

Embodiments of the present disclosure provide a method for evaluating a crack on an embankment, including: acquiring initial to-be-evaluated information corresponding to the crack on a surface of the embankment; processing the initial to-be-evaluated information based on a decomposition strategy and a preset threshold to obtain to-be-evaluated information, where the to-be-evaluated information includes geometric information of the embankment, soil information of the embankment, and environmental information corresponding to the embankment, and where the initial to-be-evaluated information is decomposed using the decomposition strategy, and the decomposed initial to-be-evaluated information is threshold-quantized using the preset threshold; and inputting the soil information, the geometric information, and the environmental information into an evaluation model to obtain a size evaluation result of the crack and a rate evaluation result of the crack, where the evaluation model includes a feature evaluation sub-model and a state evaluation sub-model.

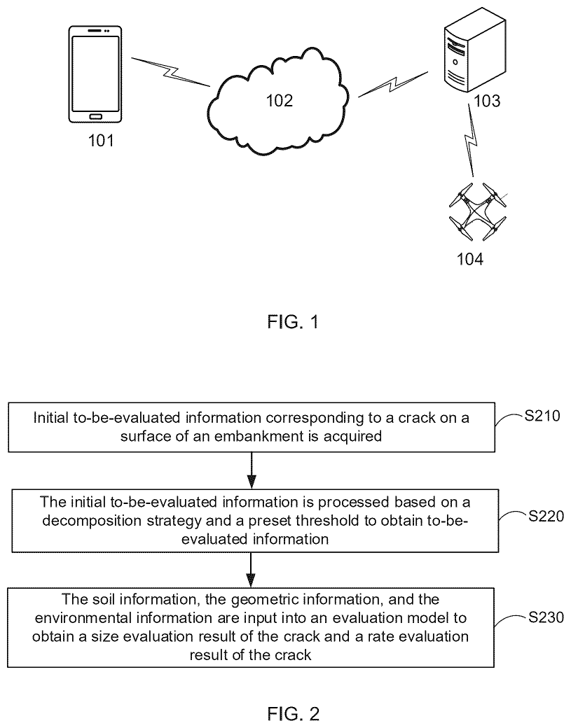

FIG. 1 shows an application scenario diagram of a method for evaluating a crack on an embankment, an apparatus for evaluating a crack on an embankment, a device, a medium, and a program product according to an embodiment of the present disclosure.

As shown in FIG. 1, an application scenario 100 according to the embodiment may include a terminal device 101, a network 102, a server 103, and a data acquisition device 104. The network 102 is a medium for providing a communication link between the terminal device 101 and the server 103. The network 102 may include various connection types, such as wired, wireless communication links, or optical fiber cables.

The data acquisition device 104 may be used to acquire geometric information of an embankment, soil information of the embankment, and environmental information of the embankment, including but not limited to a surveying/mapping UAV (unmanned aerial vehicle), a temperature sensor, a humidity sensor, and a soil pressure sensor. For example, an UAV equipped with a high-precision camera may be used to take an aerial photograph of the embankment, and photogrammetry technology may be used to generate geometric information of the embankment and a three-dimensional model of the embankment. For example, a temperature sensor and a humidity sensor may be used to real-time monitor soil temperature information, humidity information, and their variations over time. For example, a soil pressure sensor may be used to monitor the total pressure at the interface between the embankment and the soil, which may evaluate the stress state and stability of the soil.

The data acquisition device 104 may send the acquired relevant information of the embankment to the server 103. The terminal device 101 may be used by a user to interact with the server 103 through the network 102 to receive or send messages or the like.

The terminal device 101 may be any electronic device with a display screen and supporting web browsing, including but not limited to a smartphone, a tablet computer, a laptop computer, a desktop computer, and the like.

The server 103 may be a server that provides various services. The server 103 may process the received relevant information of the embankment (such as soil information, geometric information, and environmental information) to obtain the processing result of the crack on the surface of the embankment, and send the processing result to the terminal device 101.

It should be noted that the method for evaluating a crack on an embankment provided by embodiments of the present disclosure may generally be executed by the server 103. Correspondingly, the apparatus for evaluating a crack on an embankment provided by embodiments of the present disclosure may generally be provided in the server 103. Alternatively, the method for evaluating a crack on an embankment provided by embodiments of the present disclosure may be executed by a server or a server cluster different from the server 103 and capable of communicating with the terminal device 101 and/or the server 103. Correspondingly, the apparatus for evaluating a crack on an embankment provided by embodiments of the present disclosure may be provided in a server or a server cluster different from the server 103 and capable of communicating with the terminal device 101 and/or the server 103.

It should be understood that the number of terminal devices, networks, data acquisition devices, and servers shown in FIG. 1 is merely illustrative. According to implementation desires, there may be any number of terminal devices, data acquisition devices, networks, and servers.

FIG. 2 shows a flowchart of a method for evaluating a crack on an embankment according to an embodiment of the present disclosure.

As shown in FIG. 2, the method for evaluating a crack on an embankment of the embodiment includes operation S210 to operation S230.

In operation S210, initial to-be-evaluated information corresponding to a crack on a surface of an embankment is acquired.

In embodiments of the present disclosure, the embankment may be a built and in-service embankment, including at least one of a historically-built embankment or a newly-built embankment. The initial to-be-evaluated information may be multi-source information used to evaluate the development trend and state information of the existing crack on the surface of the embankment, and/or may be used to evaluate the probability of the crack appearing on the surface of the embankment in a future time period. The method and device for acquiring the initial to-be-evaluated information are based on the standards of comprehensiveness and accuracy of information acquisition, and are not limited herein.

In some embodiments, the initial to-be-evaluated information may include settlement information obtained through sensors, crack information obtained through image acquisition devices and/or measuring devices, and so on. Generally, different locations on a road may exhibit different levels of settlement. For example, the depth and rate of subsidence may vary between the middle and sides of a road, leading to uneven, distorted, and cracked pavement, thus resulting in settlement differences. Settlement information may refer to the data obtained by measuring the settlement differences at various locations on the road, while crack information may refer to details such as the width and length of cracks on the road surface.

In operation S220, the initial to-be-evaluated information is processed based on a decomposition strategy and a preset threshold to obtain to-be-evaluated information, where the to-be-evaluated information includes geometric information of an embankment, soil information of the embankment, and environmental information corresponding to the embankment, and where the initial to-be-evaluated information is decomposed using the decomposition strategy, and the decomposed initial to-be-evaluated information is threshold-quantized using the preset threshold.

In embodiments of the present disclosure, the decomposition strategy may be a method for decomposing the acquired initial to-be-evaluated information to obtain multi-dimensional decomposition coefficients. The preset threshold may represent a target threshold selected for quantizing the decomposed initial to-be-evaluated information to remove signal noise. The geometric information may include width information and height information of the embankment in different dimensions. The soil information may include state information of the embankment soil and mechanical information of the embankment soil. The environmental information may include external environmental information corresponding to the embankment and settlement deformation information corresponding to the embankment.

For example, the geometric information, soil information, and environmental information of the embankment are decomposed to obtain multi-dimensional width information and height information of the embankment, the state information of the soil and the mechanical information of the soil, and the external environmental information corresponding to the embankment and the settlement deformation information corresponding to the embankment.

In operation S230, the soil information, the geometric information, and the environmental information are input into an evaluation model to obtain a size evaluation result of the crack and a rate evaluation result of the crack, where the evaluation model includes a feature evaluation sub-model and a state evaluation sub-model.

In embodiments of the present disclosure, the feature evaluation sub-model may be used to extract key spatial relationship information of multi-source information as time-series information; the state evaluation sub-model may be used to process the extracted time-series information to obtain the long-term dependency relationship between the time-series information, thereby obtaining the size evaluation result of the crack in the future time period and the rate evaluation result of crack development. The size evaluation result may include width information of the crack, length information of the crack, and depth information of the crack.

For example, the soil information, the geometric information, and the environmental information are input into the feature evaluation sub-model to output key spatial relationship information based on time series, such that the key spatial relationship information is input into the state evaluation sub-model as input information to obtain the size evaluation result of the crack and the rate evaluation result of the crack.

According to embodiments of the present disclosure, the to-be-evaluated information processed by the decomposition strategy and the preset threshold may retain the key feature of the initial to-be-evaluated information, improving the signal-to-noise ratio and quality of the data. As the evaluation model integrates multi-source information and time-series information, enabling the feature evaluation function and state evaluation function, and the long-term trend is captured by extracting the key feature of the multi-source information, the processing of the nonlinear time-varying characteristic of the crack on the embankment is achieved, the size evaluation result of the crack and the rate evaluation result of the crack at a future moment are further obtained, the rationality and reliability of crack evaluation are improved. In this way, the future development trend of cracks can be predicted based on the evaluation results of cracks, so as to carry out early intervention and control in the crack region.

It can be understood that the above has described how to determine the size evaluation result of the crack and the rate evaluation result of the crack, and how to acquire the to-be-evaluated information will be described below.

According to embodiments of the present disclosure, the decomposition strategy includes a decomposition function and a decomposition dimension.

The processing the initial to-be-evaluated information based on a decomposition strategy and a preset threshold to obtain to-be-evaluated information includes: decomposing the initial to-be-evaluated information using the decomposition function and the decomposition dimension to obtain decomposition coefficients at a plurality of frequencies corresponding to the initial to-be-evaluated information; performing threshold quantization on the decomposition coefficients at the plurality of frequencies based on the preset threshold to obtain processing coefficients at the plurality of frequencies; and fusing the processing coefficients at the plurality of frequencies based on an inverse transformation function to obtain the to-be-evaluated information.

In embodiments of the present disclosure, the decomposition function may be a function used to decompose multi-source to-be-evaluated information to obtain features at different scales. The decomposition dimension is a decomposition dimension determined based on the decomposition function and actual requirements, and the decomposition dimension is proportional to the frequency resolution of the signal. The decomposition coefficient may be a high-frequency wavelet coefficient and/or a low-frequency wavelet coefficient obtained through the decomposition function.

In embodiments of the present disclosure, the preset threshold may be a threshold set in the quantization operation of the high-frequency wavelet coefficient or the low-frequency wavelet coefficient. Coefficients less than the preset threshold may be set to zero or subjected to other forms of quantization operations to remove or weaken a noise component and retain an important feature in the signal. The processing coefficient may be a processing result obtained after the threshold quantization processing. The inverse transformation function may gradually combine the low-frequency coefficient and the high-frequency coefficient through a reconstruction process for coefficients subjected to multi-level decomposition, and gradually restore approximate information corresponding to the original information to obtain complete to-be-evaluated information.

In the related art, the lack of comprehensive analysis of basic information of the crack on the embankment at different scales from both a macroscopic level and a microscopic level leads to the poor adaptability of the analysis process and the low accuracy of the analysis result. The present disclosure decomposes and reconstructs the acquired to-be-evaluated information through the decomposition function to obtain to-be-evaluated information with noise components removed or suppressed.

For example, for the situation that symmetric cracks are prone to occur in a widened embankment, Symlets wavelets and decomposition scales (determined according to actual desires, generally 3 to 5 layers) may be selected to perform wavelet decomposition on the preprocessed soil information, and the signal is decomposed into sub-band signals at different frequency bands. In the decomposition process, the symmetry characteristics of the cracks may be better preserved, which helps to more accurately analyze the shape and distribution of the cracks.

For example, after performing multi-level decomposition on the initial to-be-evaluated information, after obtaining processing coefficients at a plurality of frequencies, the processing coefficients may be reconstructed in a corresponding multi-level manner through the inverse transformation function, and the processed low-frequency coefficient and the processed high-frequency coefficient may be gradually combined to restore approximate versions of the original signal step by step until a complete reconstructed signal is obtained.

According to embodiments of the present disclosure, the valid information of the crack is retained while the noise is removed through the decomposition function, enabling the feature of the crack more prominent, improving the robustness of the detection algorithm to noise, and enabling stable detection of the crack in a complex environment. By comprehensively analyzing the features and change rules of the crack at different scales, a richer information basis is provided for the evaluation and prediction of the crack. For example, by analyzing the geometric features of the crack at different scales, the development trend and the potential risk of the crack are determined more accurately.

According to embodiments of the present disclosure, the method further includes: determining the decomposition function and the decomposition dimension according to at least one of a length feature of the initial to-be-evaluated information or a frequency feature of the initial to-be-evaluated information.

In embodiments of the present disclosure, the decomposition dimension may be determined by the signal length corresponding to the acquired to-be-evaluated information and the high and low frequencies corresponding to the acquired to-be-evaluated information, and the specific dimension may be determined according to actual conditions or requirements, which is not limited herein.

For example, in the processing of embankment crack information, if the focus is on the overall trend of cracks, such as the orientation and general distribution of cracks, a lower decomposition scale (e.g., 1 to 2 layers) may be selected. On the contrary, if analyzing the detailed features of cracks, such as micro-textures and small branches of cracks, a higher decomposition scale (e.g., 4 to 6 layers) may be selected.

According to embodiments of the present disclosure, the inputting the soil information, the geometric information, and the environmental information into an evaluation model to obtain a size evaluation result of the crack and a rate evaluation result of the crack includes: inputting the soil information, the geometric information, and the environmental information into the feature evaluation sub-model to output a feature evaluation result; and inputting the feature evaluation result into the state evaluation sub-model to output the size evaluation result and the rate evaluation result.

In embodiments of the present disclosure, the feature evaluation sub-model may be a deep learning model including a plurality of network layers for extracting multi-source initial to-be-evaluated information. The state evaluation sub-model may be an evaluation model based on a gating algorithm and a fusion strategy, including long short-term memory network modules in different directions.

For example, the soil information, the geometric information, and the environmental information are input into a trained convolutional neural network model to extract key spatial relationship information of multi-element data, obtaining feature evaluation results based on time series; and then the feature evaluation results are input into a trained bidirectional long short-term memory network, which simultaneously processes forward information and backward information in the time-series information to determine context information from front to back and context information from back to front in the sequence, respectively; the context information from front to back and the context information from back to front are fused at each time step to obtain the final output representation, i.e., the size evaluation result of the crack and the rate evaluation result of the crack.

According to embodiments of the present disclosure, processing the to-be-evaluated information through an evaluation model that fuses the feature evaluation sub-model and the state evaluation sub-model enables the feature evaluation sub-model to extract multi-dimensional key feature information from multi-source data, and capture spatial features of cracks, such as the distribution, form, and position of the cracks, as well as the mutual influence between different positions, thereby providing rich spatial details for prediction. For time-series data processing, the evolution rules and trends of the cracks on the embankment in the time dimension may be captured, and the forward and backward dependencies in the time series may be integrated. The spatial features and the time features may be organically fused through the fused evaluation model, and the development process of the crack of the embankment may be more comprehensively and accurately modeled, thereby improving prediction accuracy, more accurately predicting the expansion direction, speed, and degree of the crack, and providing a reliable basis for timely adoption of effective maintenance measures.

According to embodiments of the present disclosure, the feature evaluation sub-model includes an extraction layer, a transformation layer, and an update layer; and the inputting the soil information, the geometric information, and the environmental information into the feature evaluation sub-model to output a feature evaluation result includes: inputting the soil information, the geometric information, and the environmental information into the extraction layer for feature extraction to obtain initial feature information; inputting the initial feature information into the transformation layer for nonlinear transformation to obtain intermediate feature information; inputting the intermediate feature information into the update layer for dimensionality reduction and feature enhancement processing to obtain multi-dimensional feature information; and performing transformation processing on the multi-dimensional feature information to obtain the feature evaluation result.

In embodiments of the present disclosure, the extraction layer may be used to perform feature extraction on multi-dimensional to-be-evaluated information to obtain initial feature information; the transformation layer may be used to transform the extracted initial feature information by introducing a nonlinear factor to fit a more complex relationship in the data, so as to obtain intermediate feature information; the update layer is then used to perform dimensionality reduction, compression, or feature enhancement processing on the obtained intermediate feature information to retain key feature information, so as to obtain key multi-dimensional feature information.

In embodiments of the present disclosure, considering that the information format of the multi-dimensional feature information obtained by the update layer cannot be processed by the state evaluation sub-model, dimensionality reduction transformation may be performed on the multi-dimensional feature information to obtain a dimensionality-reduced feature evaluation result.

Taking the feature evaluation sub-model as a convolutional neural network and the state evaluation sub-model as a bidirectional long short-term memory network as an example, the feature information output by the feature evaluation sub-model is multi-dimensional information and has a spatial structure, such as height, width, and number of channels. However, the input information received by the state evaluation sub-model is in a sequence form, i.e., a one-dimensional vector sequence. In order to input the features extracted by the convolutional neural network into the bidirectional long short-term memory network for subsequent time-series modeling, a flattening layer may be used to convert high-dimensional features into a sequence format suitable for the input of the bidirectional long short-term memory network.

According to embodiments of the present disclosure, by performing transformation processing on the multi-dimensional feature information, the input vector at each time step contains the comprehensive features of the to-be-evaluated information at that position, such that the state evaluation sub-model may better capture the forward and backward dependencies in the time-series information, and the accuracy of the model in predicting the development of the crack of the embankment is improved.

According to embodiments of the present disclosure, the performing transformation processing on the multi-dimensional feature information to obtain the feature evaluation result includes: performing dimensionality reduction on the multi-dimensional feature information based on a time step or a feature dimension to obtain a plurality of dimensionality-reduced features; and performing feature fusion on the plurality of dimensionality-reduced features to obtain the feature evaluation result.

In embodiments of the present disclosure, dimensionality reduction processing may represent flattening multi-dimensional feature information to obtain dimensionality-reduced features. Feature fusion may represent further integrating and transforming the dimensionality-reduced features after flattening to extract higher-level feature representations.

For example, multi-dimensional feature information output from the feature evaluation sub-model is received, and the feature information has a certain height, width, and number of channels. For example, assuming the size of the feature information output by the feature evaluation sub-model is [height, width, number of channels]=[h, w, c], the feature vector at each position may be flattened, i.e., converting the three-dimensional feature information into a two-dimensional matrix. For example, the feature information may be flattened in the height and width dimensions to obtain a matrix of shape [h×w, c], where each row represents the feature vector of a position. Alternatively, if needed, flattening may be performed in the dimension of number of channels to obtain a vector sequence of shape [h×w×c, 1].

After flattening, a fully connected layer may be used to further integrate and transform the feature vectors. The fully connected layer maps each feature vector to a new feature space by learning a weight matrix and bias terms to extract higher-level feature representations. The output dimension of the fully connected layer may be set according to the input requirements of the bidirectional long short-term memory network, for example, it may be set to the input dimension of the bidirectional long short-term memory network at each time step.

In embodiments of the present disclosure, the inputting the feature evaluation result into the state evaluation sub-model to output the size evaluation result and the rate evaluation result includes: processing the feature evaluation result based on a forward propagation strategy to obtain first state information respectively corresponding to a plurality of moments, and processing the feature evaluation result based on a backward propagation strategy to obtain second state information respectively corresponding to the plurality of moments; concatenating the first state information and the second state information to obtain target state information; and performing pooling processing on the target state information to obtain the size evaluation result and the rate evaluation result.

In embodiments of the present disclosure, the first state information may represent state information obtained by processing the feature evaluation result sequentially backward from a first time step of a plurality of time steps using the forward propagation layer in the state evaluation sub-model. The second state information may represent state information obtained by processing the feature evaluation result sequentially forward from a last time step of the plurality of time steps using the backward propagation layer in the state evaluation sub-model. The target state information may be fused state information obtained by using concatenation or addition of the first state information and the second state information. Pooling processing may represent performing global pooling processing on the fused target state information.

For example, the forward long short-term memory network in the bidirectional long short-term memory network may process the feature at each time step sequentially backward from the first time step of the sequence; the backward long short-term memory network may process the feature at each time step sequentially forward from the last time step of the sequence. Through bidirectional processing, the state evaluation sub-model may capture the forward and backward dependencies and evolution trends of cracks in the time dimension. Thus, the hidden state at each time step is output by the bidirectional long short-term memory network, and the hidden state fuses the time-series information of the crack in both forward and backward directions at that time step.

Further, the time-series feature output by the bidirectional long short-term memory network may be fused with the spatial feature extracted by the convolutional neural network. The two features may be combined by means of concatenation, addition, etc., to form the final target state information, and global pooling processing is performed on the target state information to obtain the scale evaluation result of the crack and the rate evaluation result of the crack.

In embodiments of the present disclosure, the embankment includes a historically-built embankment and a newly-built embankment, the geometric information includes first geometric information of the historically-built embankment and second geometric information of the newly-built embankment, the soil information includes density information, water content information, compression modulus information, an internal friction angle, and cohesion information, and the environmental information includes temperature information, humidity information, rainfall information, and settlement deformation information.

In embodiments of the present disclosure, the first geometric information may include the embankment width, height information, and subgrade depth of the historically-built embankment, and the second geometric information may include the embankment width, height information, and subgrade depth of the newly-built embankment. The environmental information may include traffic flow information of the embankment.

For example, within a specific time range, a measuring device is used to accurately measure the settlement deformation data of the embankment, and key positions such as the junction of the historically-built embankment and the newly-built embankment, an embankment side slope, and an embankment bottom may be measured in a targeted manner; a crack observer is used to record key information such as the width and length of the crack in detail, and an ultrasonic method is used to measure the depth of the crack; a temperature and humidity sensor, a rain gauge, and other devices are deployed to collect real-time data on environmental factors such as temperature, humidity, and rainfall on-site and in the surrounding environment, and traffic flow information is obtained from a relevant database; detailed construction drawings may also be collected to obtain construction process-related parameters and physical and mechanical parameters of subgrade soil.

In embodiments of the present disclosure, the evaluation model is trained through the following operations: acquiring sample initial to-be-evaluated information corresponding to a crack on a surface of a sample embankment; processing the sample initial to-be-evaluated information based on the decomposition strategy and the preset threshold to obtain sample to-be-evaluated information, where the sample to-be-evaluated information includes sample geometric information of the sample embankment, sample soil information of the sample embankment, sample crack information of the sample embankment, and sample environmental information corresponding to the sample embankment based on different types, the sample initial to-be-evaluated information is decomposed using the decomposition strategy, and the decomposed sample initial to-be-evaluated information is threshold-quantized using the preset threshold; and training an initial evaluation model using the sample crack information, the sample geometric information, the sample soil information, and the sample environmental information to obtain the evaluation model meeting a preset evaluation condition.

In embodiments of the present disclosure, the process of processing the sample initial to-be-evaluated information based on the decomposition strategy and the preset threshold to obtain the sample to-be-evaluated information is the same as the process of processing the initial to-be-evaluated information based on the decomposition strategy and the preset threshold to obtain the to-be-evaluated information in the application stage, which is not described in detail herein.

In embodiments of the present disclosure, considering the influence of different data dimensions of multi-source information, normalization processing may be performed on the sample to-be-evaluated information to eliminate the influence of multi-source data dimensions and improve model training efficiency. The Min-Max normalization method is adopted to scale the feature value to between 0 and 1, as shown in the following equation (1):

$${X}^{′} = \frac{X - {X}_{min}}{{X}_{max} - {X}_{min}} ; \qquad ( 1 )$$

where X′ may be normalized data; X may be original data; Xₘᵢₙ may be a minimum value in the data; Xₘₐₓ may be a maximum value in the data.

For example, the initial evaluation model may include an initial feature evaluation sub-model and an initial state evaluation sub-model. Taking a hybrid model where the initial feature evaluation sub-model is a Convolutional Neural Network (CNN) and the initial state evaluation sub-model is a Bidirectional Long Short-Term Memory network (BiLSTM) as an example, the initial feature evaluation sub-model and the initial state evaluation sub-model may be regarded as the CNN layer and the BiLSTM layer of the initial evaluation model.

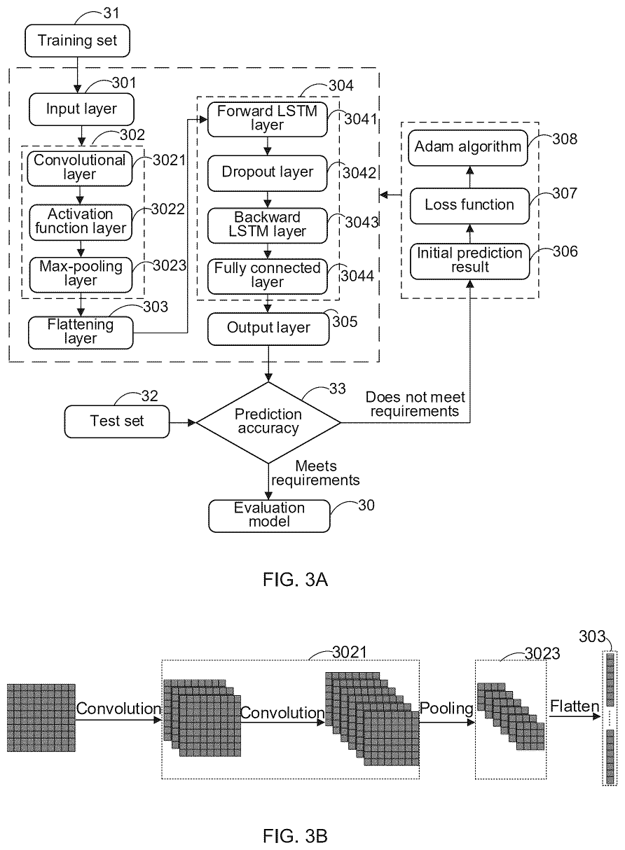

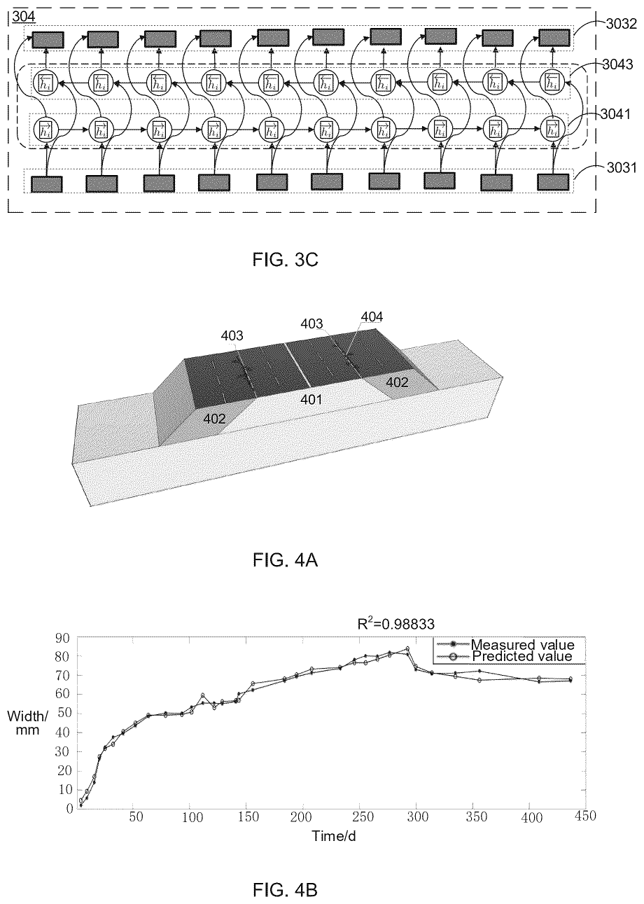

FIG. 3A shows an exemplary schematic diagram of a training process of an initial evaluation model according to an embodiment of the present disclosure.

As shown in FIG. 3A, the sample to-be-evaluated information may be divided into a training set 31 and a test set 32. The initial evaluation model may include an input layer 301, a CNN layer 302, a flattening layer 303, a BiLSTM layer 304, and an output layer 305. The CNN layer 302 may include a convolutional layer 3021, an activation function layer 3022, and a max-pooling layer 3023 that are stacked. The BiLSTM layer 304 may include a forward LSTM layer 3041, a Dropout layer 3042, a backward LSTM 3043, and a fully connected layer 3044. The CNN layer 302 may be used to extract key spatial relationship information of multi-source data, and the BiLSTM layer 304 may be used to acquire long-term dependency information related to the time series.

The data in the training set 31 is serialized according to time steps, and the serialized data is input into the input layer 301, where each time step includes all feature value information; the convolutional layer 3021 in the CNN layer 302 is used to perform convolution operation on the input data, the spatial relationship between the parameter of the widened embankment and the generated crack is extracted to generate a spatial feature.

FIG. 3B shows a schematic structural diagram of a CNN layer according to an embodiment of the present disclosure.

As shown in FIG. 3B, the convolutional layer 3021 performs convolution operation on the input sample to-be-evaluated information. A 2×2 convolution kernel may be set, and the data is processed by window sliding to obtain the spatial relationship between the parameter of the widened embankment and the generated crack, generating a feature matrix (feature map). Setting two convolutional layers may further combine and refine key features of the processed data, which is specifically shown in the following equation (2):

A̅_̅{̅i̅,̅j̅}̅=f_{cov}(ΣₙΣₘw_{n,m}A_{i+n,j+m}+b_{n,m}) (2);
where, A_{i+m,j+n} may be an element in the input matrix, whose position is determined by the current output position (i,j) and the position (n,m) of the convolution kernel; f_{cov} may be an activation function; w_{m,n} may be the weight of the convolution kernel at the m-th row and n-th column; b_{m,n} may be the bias parameter of the convolution kernel at the m-th row and n-th column; i and j may be the position of the output feature map; A̅_̅{̅i̅,̅j̅}̅ may be an element in the output matrix or feature map, located in the i-th row and j-th column; Σ may be a summation symbol, indicating weighted summation of elements within the area covered by the convolution kernel.

The activation function layer may use the ReLu activation function to activate the extracted spatial features and introduce nonlinearity. The max-pooling layer 3023 may perform max-pooling dimensionality reduction operation on the feature map generated by the convolutional layer 3021. The pooling window is set to 2×2 with a stride of 2, and the maximum value is taken within the local area of the data, to reduce the data dimension, enhance the robustness of the model, and retain key features in the data, generating several feature maps. The flattening layer 303 operates in the form of a fully connected layer, integrating the feature vectors generated by the CNN layer 302 to adapt to the input form required by the BiLSTM layer 304.

FIG. 3C shows a schematic structural diagram of a BiLSTM layer according to an embodiment of the present disclosure.

As shown in FIG. 3C, the results of the flattening layer 303 may be arranged in time sequence as an input 3031. Through operations of the forward LSTM layer 3041 and backward LSTM 3043, the forward and backward information of crack features in the time dimension is learned simultaneously, and the forward and backward results are combined to obtain an output result 3032; the architecture is configured with two layers, and a Dropout layer 3042 with a dropout rate of 0.2 is added between the two layers to improve the generalization capability and performance of the model, prevent the over-fitting problem, and enhance robustness; the calculation equations of the BiLSTM layer may be the following equations (3) to (8):

iₜ=σ(Wₓᵢxₜ+Wₕᵢhₜ₋₁+bᵢ) (3);

fₜ=σ(W_{xf}xₜ+W_{hf}hₜ₋₁+b_{f}) (4);

oₜ=σ(Wₓₒxₜ+Wₕₒhₜ₋₁+bₒ) (5);

cₜ=fₜ⊙cₜ₋₁+iₜ⊙ tanh(W_{xc}xₜ+W_{hc}hₜ₋₁+b_{c}) (6);

hₜ=oₜ⊙ tanh(cₜ) (7);

hₜ=┌\vec{hₜ}; [symbol] ┐ (8);
where xₜ is input data; iₜ, fₜ, and oₜ are the values of a input gate, a forget gate, and an output gate, respectively; cₜ is a cell state; hₜ is a hidden state; σ is a Sigmoid function; ⊙ is element-wise multiplication; w is the weight; and b is a bias parameter.

As shown in FIG. 3A, the output layer 305 may be connected through the fully connected layer 3044, and a multiple output result may be set to output the width, length, depth, and development rate of the crack.

The training set may be used for iterative training and hyperparameter optimization of the initial evaluation model. The hyperparameter optimization may adopt the Adam algorithm 308, which combines the advantages of the Adagrad algorithm and RMSProp algorithm; the learning rate of each parameter is dynamically adjusted based on the first-order moment estimation and second-order moment estimation of the gradient; the learning rate may be dynamically adjusted according to the gradient history information of each parameter, assigning a larger learning rate to parameter updates with lower frequency and a smaller learning rate to parameter updates with higher frequency, thereby converging to the optimal solution faster in the training process.

For example, the Adam algorithm 308 may be initialized with a learning rate of 0.001, a first-order moment estimation β₁=0.8, a second-order moment estimation β₂=0.999, and a constant term ε=e⁻⁸; for forward propagation, given input data may be input into the constructed initial evaluation model, calculated according to the structure and parameters of the neural network, and sequentially passed through the input layer 301, the CNN layer 302, the flattening layer 303, the BiLSTM layer 304, and the output layer 305 to obtain the initial prediction result 306 of the network; a loss function 307 is calculated according to the prediction result and the true value, and the mean squared error is used as the loss function to evaluate the neural network; then backpropagation is performed, and the gradient of the loss function with respect to each parameter is calculated using a chain rule, as shown in the following equations (9) to (11):

$$MSE ( θ ) = \frac{1}{n} {\sum }_{i = 1}^{n} {( {y}_{i} - \text{?} )}^{2} ; \qquad ( 9 )$$

$${∇}_{θ} MSE ( θ ) = ( \frac{\partial MSE}{\partial {θ}_{1}} , \frac{\partial MSE}{\partial {θ}_{2}} , … , \frac{\partial MSE}{\partial {θ}_{m}} ) ; \qquad ( 10 )$$

$$\frac{\partial MSE}{\partial {θ}_{i}} = \frac{2}{n} {\sum }_{1}^{n} ( {y}_{i} - \text{?} ) \cdot \frac{\partial \text{?}}{\partial {θ}_{i}} ; \qquad ( 11 )$$

where MSE(θ) may be a loss function; n may be the number of samples; yᵢ may be the true value of the i-th sample; [symbol] may be the corresponding predicted value; the gradient vector of the loss function with respect to parameter θ is represented by the partial derivative ∇_{θ}MSE(θ) of the loss function with respect to the parameter; m may be the total number of parameters.

The Adam algorithm 308 may be used to update the parameters according to the calculated gradients in accordance with rules to minimize the loss function; the above operation steps are repeated until all samples are processed, and the prediction accuracy 33 of the model is determined. If the prediction accuracy 33 meets the requirement, the model is determined as the evaluation model 30; otherwise, the parameters are adjusted for further optimization; the test set 32 is used to evaluate the performance and accuracy of the model, and the evaluation parameter adopts a determination coefficient (R²). The closer the determination coefficient is to 1, the better the prediction performance of the model is; the closer the determination coefficient is to 0, the worse the prediction effect of the model is. The calculation method of the determination coefficient R² is shown in the following equation (12):

$${R}^{2} = 1 - \frac{\sum {( {y}_{i} - \text{?} )}^{2}}{\sum {( {y}_{i} - \overline{{y}_{1}} )}^{2}} ; \qquad ( 12 )$$

where yᵢ may be the true value of the i-th sample; [symbol] may be the corresponding predicted value, i.e., the value obtained by predicting each sample point according to the regression model; y̅ᵢ̅ may be the average value of the observed values, used to measure the central position of the data. Σ(yᵢ− [symbol] )² may represent the sum of squared residuals, indicating the sum of squares of the differences between the model's predicted values and the actual observed values, reflecting the error of the model in fitting the data. Σ(yᵢ−y̅ᵢ̅)² may represent the sum of the squares of the total deviations, indicating the sum of squares of the differences between the actual observed values and the average value, reflecting the variability of the data itself.

The evaluation model in embodiments of the present disclosure includes a CNN-BiLSTM hybrid architecture designed for the temporal and spatial characteristics of cracks on the embankment. The feature evaluation sub-model (CNN part) is used to extract the morphological correlation of cracks in the spatial dimension, such as the local correlation between geometric deformations in different regions of the embankment and crack locations. Its convolution kernel size and pooling strategy aim to capture the spatial topological features of the embankment structure. The state evaluation sub-model (BiLSTM part) is used to model the nonlinear dynamic process of crack development in the temporal dimension. Its bidirectional structure can simultaneously consider historical trends and potential future influencing factors, thereby capturing engineering phenomena such as “hysteresis effects”. The output of the model (size, rate) is directly corresponding to the core quantitative indicators for engineering decision-making, and can be directly used to guide the scheduling of maintenance resources and the initiation of risk intervention measures. Compared to related technologies that suffer from issues such as feature loss, inaccurate prediction, and reliance on human experience when dealing with multi-source, non-stationary, and high-noise embankment monitoring data, the evaluation method in embodiments of the present disclosure achieves automated, high-precision, real-time evaluation of crack size and development rate through a specific decomposition strategy, threshold quantification combined with the CNN-BiLSTM hybrid model, thereby enhancing the ability of engineering safety early warning.

FIG. 4A shows a three-dimensional schematic diagram of a longitudinal crack in a widened embankment according to an embodiment of the present disclosure.

As shown in FIG. 4A, verification was conducted by selecting a section of widened embankment in City A. The widened embankment includes a historically-built embankment 401 and a newly-built embankment 402, and a plurality of longitudinal cracks 404 have occurred along a junction 403 of the historically-built embankment and the newly-built embankment.

FIG. 4B shows a comparison diagram of a measured value of a crack width of a widened embankment and a predicted value of the crack width of the widened embankment according to an embodiment of the present disclosure.

The soil information, the geometric information, and the environmental information obtained by processing a section of widened embankment in City A in a time sequence are used as the input of the constructed CNN-BILSTM model. After a series of iterative training and hyperparameter optimization, the evaluation value obtained by the intermediate evaluation model is obtained. As shown in FIG. 4B, the predicted value is compared with the measured value measured by the actual detection device to obtain a comparison result, and the determination coefficient (R²) is 0.98833, indicating that the prediction result of the trained model may meet the actual prediction accuracy requirements, and verifying the rationality and feasibility of the method for evaluating a crack.

The above method for evaluating a crack on an embankment can be deployed and operated within an intelligent pavement health monitoring system. This system includes: a physical sensor network (such as surveying drones, temperature sensors, humidity sensors, and soil pressure sensors) for acquiring initial to-be-evaluated information; edge computing devices or cloud servers for executing the above method; and a graphical warning interface for presenting size and rate evaluation results. By operating within a physical system, this method achieves real-time, automated, and high-precision perception and prediction of the structural state of the embankment, transforming the existing passive mode relying on manual inspection and lag analysis into an active warning mode driven by continuous data.

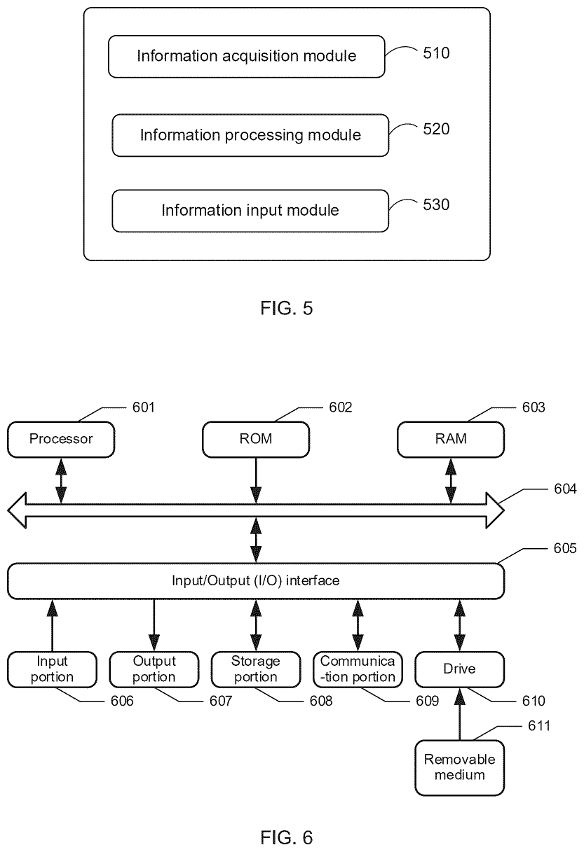

Based on the above method for evaluating a crack on an embankment, the present disclosure further provides an apparatus for evaluating a crack on an embankment. The apparatus will be described in detail below with reference to FIG. 5.

FIG. 5 shows a structural block diagram of an apparatus for evaluating a crack on an embankment according to an embodiment of the present disclosure.

As shown in FIG. 5, the apparatus for evaluating a crack on an embankment of the embodiment includes an information acquisition module 510, an information processing module 520, and an information input module 530.

The information acquisition module 510 is used to acquire initial to-be-evaluated information corresponding to a crack on a surface of the embankment. In an embodiment, the information acquisition module 510 may be used to perform the operation S210 described above, which is not described in detail herein.

The information processing module 520 is used to process the initial to-be-evaluated information based on a decomposition strategy and a preset threshold to obtain to-be-evaluated information, where the to-be-evaluated information includes geometric information of the embankment, soil information of the embankment, and environmental information corresponding to the embankment based on different types, and where the initial to-be-evaluated information is decomposed using the decomposition strategy, and the decomposed initial to-be-evaluated information is threshold-quantized using the preset threshold. In an embodiment, the information processing module 520 may be used to perform the operation S220 described above, which is not described in detail herein.

The information input module 530 is used to input the soil information, the geometric information, and the environmental information into an evaluation model to obtain a size evaluation result of the crack and a rate evaluation result of the crack, where the evaluation model includes a feature evaluation sub-model and a state evaluation sub-model based on different functions. In an embodiment, the information input module 530 may be used to perform the operation S230 described above, which is not described in detail herein.

According to embodiments of the present disclosure, through the information acquisition module 510, the information processing module 520, and the information input module 530 in the apparatus for evaluating a crack on an embankment, the to-be-evaluated information processed by the decomposition strategy and the preset threshold may retain the key feature of the initial to-be-evaluated information, improving the signal-to-noise ratio and quality of the data. Since an evaluation model fuses the feature and state evaluation functions for multi-source information and time-series information, the long-term trend is captured by extracting the key feature of the multi-source information, the processing of the nonlinear time-varying characteristic of the crack on the embankment is achieved, the size evaluation result of the crack and the rate evaluation result of the crack at a future moment are further obtained, the rationality and reliability of crack evaluation are improved.

According to embodiments of the present disclosure, the decomposition strategy includes a decomposition function and a decomposition dimension; the information processing module 520 includes: an information decomposition sub-module, a quantization sub-module, and a coefficient fusion sub-module. The information decomposition sub-module is used to decompose the initial to-be-evaluated information using the decomposition function and the decomposition dimension to obtain decomposition coefficients at a plurality of frequencies corresponding to the initial to-be-evaluated information; the quantization sub-module is used to perform threshold quantization on the decomposition coefficients at the plurality of frequencies based on the preset threshold to obtain processing coefficients at the plurality of frequencies; the coefficient fusion sub-module is used to fuse the processing coefficients at the plurality of frequencies based on an inverse transformation function to obtain the to-be-evaluated information.

According to embodiments of the present disclosure, the apparatus further includes: a dimension determination module, used to determine the decomposition function and the decomposition dimension according to at least one of a length feature of the initial to-be-evaluated information or a frequency feature of the initial to-be-evaluated information.

According to embodiments of the present disclosure, the information input module 530 includes: a result output sub-module and a result input sub-module. The result output sub-module is used to input the soil information, the geometric information, and the environmental information into the feature evaluation sub-model to output a feature evaluation result; the result input sub-module is used to input the feature evaluation result into the state evaluation sub-model to output the size evaluation result and the rate evaluation result.

According to embodiments of the present disclosure, the feature evaluation sub-model includes an extraction layer, a transformation layer, and an update layer; the result output sub-module includes: an extraction unit, a transformation unit, an enhancement unit, and an information conversion unit. The extraction unit is used to input the soil information, the geometric information, and the environmental information into the extraction layer for feature extraction to obtain initial feature information; the transformation unit is used to input the initial feature information into the transformation layer for nonlinear transformation to obtain intermediate feature information; the enhancement unit is used to input the intermediate feature information into the update layer for dimensionality reduction and feature enhancement processing to obtain multi-dimensional feature information; and the information conversion unit is used to perform transformation processing on the multi-dimensional feature information to obtain the feature evaluation result.

According to embodiments of the present disclosure, the information conversion unit includes: a dimensionality reduction sub-unit and a fusion sub-unit. The dimensionality reduction sub-unit is used to perform dimensionality reduction on the multi-dimensional feature information based on a time step or a feature dimension to obtain a plurality of dimensionality-reduced features; the fusion sub-unit is used to perform feature fusion on the plurality of dimensionality-reduced features to obtain the feature evaluation result.

According to embodiments of the present disclosure, the result input sub-module includes: a result processing unit, a concatenation unit, and a pooling processing unit. The result processing unit is used to process the feature evaluation result based on a forward propagation strategy to obtain first state information respectively corresponding to a plurality of moments, and process the feature evaluation result based on a backward propagation strategy to obtain second state information respectively corresponding to the plurality of moments; the concatenation unit is used to concatenate the first state information and the second state information to obtain target state information; the pooling processing unit is used to perform pooling processing on the target state information to obtain the size evaluation result and the rate evaluation result.

According to embodiments of the present disclosure, the embankment includes a historically-built embankment and a newly-built embankment; the geometric information includes first geometric information of the historically-built embankment and second geometric information of the newly-built embankment; the soil information includes density information, water content information, compression modulus information, an internal friction angle, and cohesion information; the environmental information includes temperature information, humidity information, rainfall information, and settlement deformation information.

According to embodiments of the present disclosure, the evaluation model is trained through the following operations: acquiring sample initial to-be-evaluated information corresponding to a crack on a surface of a sample embankment; processing the sample initial to-be-evaluated information based on the decomposition strategy and the preset threshold to obtain sample to-be-evaluated information, where the sample to-be-evaluated information includes sample geometric information of the sample embankment, sample soil information of the sample embankment, sample crack information of the sample embankment, and sample environmental information corresponding to the sample embankment based on different types, the sample initial to-be-evaluated information is decomposed using the decomposition strategy, and the decomposed sample initial to-be-evaluated information is threshold-quantized using the preset threshold; and training an initial evaluation model using the sample crack information, the sample geometric information, the sample soil information, and the sample environmental information to obtain the evaluation model meeting a preset evaluation condition.

According to embodiments of the present disclosure, any number of the information acquisition module 510, the information processing module 520, or the information input module 530 may be combined into one module to be implemented or any one of the modules may be divided into a plurality of modules. Alternatively, at least part of the function of one or more of these modules may be combined with at least part of the function of other modules and implemented in one module. According to embodiments of the present disclosure, at least one of the information acquisition module 510, the information processing module 520, or the information input module 530 may be implemented at least partially as a hardware circuit, such as a field programmable gate array (FPGA), a programmable logic array (PLA), a system on a chip, a system on a substrate, a system on a package, an application specific integrated circuit (ASIC), or may be implemented by any other reasonable means of hardware or firmware that integrates or packages a circuit, or may be implemented in any one of or a suitable combination of three implementation methods of software, hardware and firmware. Alternatively, at least one of the information acquisition module 510, the information processing module 520, or the information input module 530 may be implemented at least partially as a computer program module, which when executed, may perform a corresponding function.

FIG. 6 shows a block diagram of an electronic device suitable for implementing a method for evaluating a crack on an embankment according to an embodiment of the present disclosure.

As shown in FIG. 6, the electronic device 600 according to embodiments of the present disclosure includes a processor 601 that may perform various appropriate actions and processes according to programs stored in a read-only memory (ROM) 602 or programs loaded from a storage portion 608 into a random access memory (RAM) 603. The processor 601 may include, for example, a general-purpose microprocessor (e.g., a CPU), an instruction set processor and/or a related chipset and/or a special-purpose microprocessor (e.g., an application-specific integrated circuit (ASIC)), etc. The processor 601 may also include an on-board memory for caching purposes. The processor 601 may include a single processing unit or a plurality of processing units for performing different actions of a method flow according to embodiments of the present disclosure.

In the RAM 603, various programs and data required for the operation of the electronic device are stored. The processor 601, the ROM 602 and the RAM 603 are connected to each other through a bus 604. The processor 601 performs various operations of the method flow according to embodiments of the present disclosure by executing the programs in the ROM 602 and/or the RAM 603. It should be noted that the programs may also be stored in one or more memories other than the ROM 602 and the RAM 603. The processor 601 may also perform various operations of the method flow according to embodiments of the present disclosure by executing the programs stored in the one or more memories.

According to embodiments of the present disclosure, the electronic device may also include an input/output (I/O) interface 605, and the input/output (I/O) interface 605 is also connected to the bus 604. The electronic device may also include one or more of the following components connected to the input/output (I/O) interface 605: an input portion 606 including a keyboard, a mouse, etc.; an output portion 607 including a cathode ray tube (CRT), a liquid crystal display (LCD), etc., and a speaker, etc.; a storage portion 608 including a hard disk, etc.; and a communication portion 609 including a network interface card such as a LAN card, a modem, etc. The communication portion 609 performs communication processing via a network such as the Internet. A drive 610 is also connected to the input/output (I/O) interface 605 as needed. A removable medium 611, such as a magnetic disk, an optical disk, a magneto-optical disk, a semiconductor memory, etc., is mounted on the drive 610 as needed so that a computer program read therefrom is installed into the storage portion 608 as needed.

The present disclosure further provides a computer-readable storage medium. The computer-readable storage medium may be included in the device/apparatus/system described in the above-mentioned embodiments, and may also exist alone without being assembled into the device/apparatus/system. The computer-readable storage medium described above carries one or more programs, and when the one or more programs are executed, the method according to embodiments of the present disclosure may be implemented.

According to embodiments of the present disclosure, the computer-readable storage medium may be a nonvolatile computer-readable storage medium. The computer-readable storage medium may include, for example, but are not limited to, a portable computer disk, a hard disk, a random access memory (RAM), a read only memory (ROM), an erasable programmable read only memory (EPROM or flash memory), a portable compact disk read only memory (CD-ROM), an optical storage device, a magnetic storage device, or any suitable combination of the above. In the present disclosure, the computer-readable storage medium may be any tangible medium that contains or stores a program that may be used by or in conjunction with an instruction execution system, apparatus, or device. For example, according to embodiments of the present disclosure, the computer-readable storage medium may include one or more memories other than the ROM 602 and/or the RAM 603 and/or the ROM 602 and the RAM 603 described above.

Embodiments of the present disclosure further include a computer program product which includes a computer program, and the computer program contains program code for performing the method illustrated in the flowchart. When the computer program product runs on a computer system, the program code is used to enable the computer system to implement the method for evaluating a crack on an embankment provided by embodiments of the present disclosure.

When the computer program is executed by the processor 601, the above-mentioned functions defined in the system/apparatus of embodiments of the present disclosure are performed. According to embodiments of the present disclosure, the system, apparatus, module, unit, etc. described above may be realized by the computer program module.

In an embodiment, the computer program may rely on a tangible storage media such as an optical storage device and a magnetic storage device. In another embodiment, the computer program may also be transmitted and distributed in a form of signals on a network media, downloaded through the communication portion 609 and installed, and/or installed from the removable medium 611. The program code contained in the computer program may be transmitted by any appropriate network medium, including but not limited to: wireless, wired, etc., or any suitable combination of the above.

In such an embodiment, the computer program may be downloaded from the network via the communication portion 609 and installed, and/or installed from the removable medium 611. The computer program, when executed by the processor 601, performs the functions described above defined in the system of embodiments of the present disclosure. According to embodiments of the present disclosure, the system, device, apparatus, module, unit, etc. described above may be implemented by the computer program module.

According to embodiments of the present disclosure, program codes for implementing the computer programs provided by embodiments of the present disclosure may be written in one programming language or any combination of more programming languages. Specifically, the computing programs may be implemented using advanced procedure-oriented and/or object-oriented programming languages, and/or assembler/machine languages. Programming languages include but are not limited to Java, C++, Python, “C” or similar programming languages. The program codes may be executed entirely on a user computing device, partially on a user device and partially on a remote computing device, or entirely on a remote computing device or server. In situations involving the remote computing device, the remote computing device may be connected to the user computing device through any kind of network, including a local area network (LAN) or a wide area network (WAN), or the user computing device may be connected to an external computing device (for example, using an Internet service provider to connect via the Internet).

The flowcharts and block diagrams in the drawings illustrate the architecture, functionality, and operation of possible implementations of systems, methods and computer program products according to various embodiments of the present disclosure. In this regard, each block in the flowcharts or block diagrams may represent a module, program segment, or portion of code, which contains one or more executable instructions for implementing the specified logical function. It should also be noted that, in some alternative implementations, the functions noted in the blocks may occur out of the order noted in the drawings. For example, two blocks shown in succession may, in fact, be executed substantially concurrently, or the two blocks may sometimes be executed in a reverse order, depending upon the functionality involved. It should also be noted that each block of the block diagrams or flowcharts, and combinations of the blocks in the block diagrams or flowcharts, may be implemented by using a special purpose hardware-based system that performs the specified functions or operations, or may be implemented using a combination of a special purpose hardware and computer instructions.

Those skilled in the art will appreciate that features recited in the various embodiments of the present disclosure may be combined and/or incorporated in a variety of ways, even if such combinations or incorporations are not clearly recited in the present disclosure. In particular, the features recited in the various embodiments of the present disclosure may be combined and/or incorporated in a variety of ways without departing from the spirit and teachings of the present disclosure, and all such combinations and/or incorporations fall within the scope of the present disclosure.

Embodiments of the present disclosure have been described above. However, these embodiments are for illustrative purposes only, and are not intended to limit the scope of the present disclosure. Although the various embodiments are described above separately, this does not mean that the measures in the various embodiments may not be advantageously used in combination. Without departing from the scope of the present disclosure, those skilled in the art may make various substitutions and modifications, and these substitutions and modifications should all fall within the scope of the present disclosure.

What is claimed is:

1. A method for evaluating a crack on an embankment, comprising:
acquiring initial to-be-evaluated information corresponding to the crack on a surface of the embankment;
processing the initial to-be-evaluated information based on a decomposition strategy and a preset threshold to obtain to-be-evaluated information, wherein the to-be-evaluated information comprises geometric information of the embankment, soil information of the embankment, and environmental information corresponding to the embankment, and wherein the initial to-be-evaluated information is decomposed using the decomposition strategy, and the decomposed initial to-be-evaluated information is threshold-quantized using the preset threshold; and
inputting the soil information, the geometric information, and the environmental information into an evaluation model to obtain a size evaluation result of the crack and a rate evaluation result of the crack, wherein the evaluation model comprises a feature evaluation sub-model and a state evaluation sub-model, the feature evaluation sub-model comprises an extraction layer, a transformation layer, and an update layer,
wherein the inputting the soil information, the geometric information, and the environmental information into an evaluation model to obtain a size evaluation result of the crack and a rate evaluation result of the crack comprises:
inputting the soil information, the geometric information, and the environmental information into the extraction layer for feature extraction to obtain initial feature information;
inputting the initial feature information into the transformation layer for nonlinear transformation to obtain intermediate feature information;
inputting the intermediate feature information into the update layer for dimensionality reduction and feature enhancement processing to obtain multi-dimensional feature information;
performing transformation processing on the multi-dimensional feature information to obtain the feature evaluation result; and
inputting the feature evaluation result into the state evaluation sub-model to output the size evaluation result and the rate evaluation result.

2. The method according to claim 1, wherein the decomposition strategy comprises a decomposition function and a decomposition dimension; and
the processing the initial to-be-evaluated information based on a decomposition strategy and a preset threshold to obtain to-be-evaluated information comprises:
decomposing the initial to-be-evaluated information using the decomposition function and the decomposition dimension to obtain decomposition coefficients at a plurality of frequencies corresponding to the initial to-be-evaluated information;
performing threshold quantization on the decomposition coefficients at the plurality of frequencies based on the preset threshold to obtain processing coefficients at the plurality of frequencies; and
fusing the processing coefficients at the plurality of frequencies based on an inverse transformation function to obtain the to-be-evaluated information.

3. The method according to claim 2, further comprising:
determining the decomposition function and the decomposition dimension according to at least one of a length feature of the initial to-be-evaluated information or a frequency feature of the initial to-be-evaluated information.

4. The method according to claim 1, wherein the performing transformation processing on the multi-dimensional feature information to obtain the feature evaluation result comprises:
performing dimensionality reduction on the multi-dimensional feature information based on a time step or a feature dimension to obtain a plurality of dimensionality-reduced features; and
performing feature fusion on the plurality of dimensionality-reduced features to obtain the feature evaluation result.

5. The method according to claim 1, the inputting the feature evaluation result into the state evaluation sub-model to output the size evaluation result and the rate evaluation result comprises:
processing the feature evaluation result based on a forward propagation strategy to obtain first state information respectively corresponding to a plurality of moments, and processing the feature evaluation result based on a backward propagation strategy to obtain second state information respectively corresponding to the plurality of moments;
concatenating the first state information and the second state information to obtain target state information; and
performing pooling processing on the target state information to obtain the size evaluation result and the rate evaluation result.

6. The method according to claim 1, wherein the embankment comprises a historically-built embankment and a newly-built embankment, the geometric information comprises first geometric information of the historically-built embankment and second geometric information of the newly-built embankment, the soil information comprises density information, water content information, compression modulus information, an internal friction angle, and cohesion information, and the environmental information comprises temperature information, humidity information, rainfall information, and settlement deformation information.

7. The method according to claim 1, wherein the evaluation model is trained by:
acquiring sample initial to-be-evaluated information corresponding to a crack on a surface of a sample embankment;
processing the sample initial to-be-evaluated information based on the decomposition strategy and the preset threshold to obtain sample to-be-evaluated information, wherein the sample to-be-evaluated information comprises sample geometric information of the sample embankment, sample soil information of the sample embankment, sample crack information of the sample embankment, and sample environmental information corresponding to the sample embankment based on different types, the sample initial to-be-evaluated information is decomposed using the decomposition strategy, and the decomposed sample initial to-be-evaluated information is threshold-quantized using the preset threshold; and
training an initial evaluation model using the sample crack information, the sample geometric information, the sample soil information, and the sample environmental information to obtain the evaluation model meeting a preset evaluation condition.

8. The method according to claim 2, wherein the evaluation model is trained by:
acquiring sample initial to-be-evaluated information corresponding to a crack on a surface of a sample embankment;
processing the sample initial to-be-evaluated information based on the decomposition strategy and the preset threshold to obtain sample to-be-evaluated information, wherein the sample to-be-evaluated information comprises sample geometric information of the sample embankment, sample soil information of the sample embankment, sample crack information of the sample embankment, and sample environmental information corresponding to the sample embankment based on different types, the sample initial to-be-evaluated information is decomposed using the decomposition strategy, and the decomposed sample initial to-be-evaluated information is threshold-quantized using the preset threshold; and
training an initial evaluation model using the sample crack information, the sample geometric information, the sample soil information, and the sample environmental information to obtain the evaluation model meeting a preset evaluation condition.

9. The method according to claim 3, wherein the evaluation model is trained by:
acquiring sample initial to-be-evaluated information corresponding to a crack on a surface of a sample embankment;
processing the sample initial to-be-evaluated information based on the decomposition strategy and the preset threshold to obtain sample to-be-evaluated information, wherein the sample to-be-evaluated information comprises sample geometric information of the sample embankment, sample soil information of the sample embankment, sample crack information of the sample embankment, and sample environmental information corresponding to the sample embankment based on different types, the sample initial to-be-evaluated information is decomposed using the decomposition strategy, and the decomposed sample initial to-be-evaluated information is threshold-quantized using the preset threshold; and
training an initial evaluation model using the sample crack information, the sample geometric information, the sample soil information, and the sample environmental information to obtain the evaluation model meeting a preset evaluation condition.

10. The method according to claim 4, wherein the evaluation model is trained by:
acquiring sample initial to-be-evaluated information corresponding to a crack on a surface of a sample embankment;
processing the sample initial to-be-evaluated information based on the decomposition strategy and the preset threshold to obtain sample to-be-evaluated information, wherein the sample to-be-evaluated information comprises sample geometric information of the sample embankment, sample soil information of the sample embankment, sample crack information of the sample embankment, and sample environmental information corresponding to the sample embankment based on different types, the sample initial to-be-evaluated information is decomposed using the decomposition strategy, and the decomposed sample initial to-be-evaluated information is threshold-quantized using the preset threshold; and
training an initial evaluation model using the sample crack information, the sample geometric information, the sample soil information, and the sample environmental information to obtain the evaluation model meeting a preset evaluation condition.

11. The method according to claim 5, wherein the evaluation model is trained by:
acquiring sample initial to-be-evaluated information corresponding to a crack on a surface of a sample embankment;
processing the sample initial to-be-evaluated information based on the decomposition strategy and the preset threshold to obtain sample to-be-evaluated information, wherein the sample to-be-evaluated information comprises sample geometric information of the sample embankment, sample soil information of the sample embankment, sample crack information of the sample embankment, and sample environmental information corresponding to the sample embankment based on different types, the sample initial to-be-evaluated information is decomposed using the decomposition strategy, and the decomposed sample initial to-be-evaluated information is threshold-quantized using the preset threshold; and
training an initial evaluation model using the sample crack information, the sample geometric information, the sample soil information, and the sample environmental information to obtain the evaluation model meeting a preset evaluation condition.

12. The method according to claim 6, wherein the evaluation model is trained by:
acquiring sample initial to-be-evaluated information corresponding to a crack on a surface of a sample embankment;
processing the sample initial to-be-evaluated information based on the decomposition strategy and the preset threshold to obtain sample to-be-evaluated information, wherein the sample to-be-evaluated information comprises sample geometric information of the sample embankment, sample soil information of the sample embankment, sample crack information of the sample embankment, and sample environmental information corresponding to the sample embankment based on different types, the sample initial to-be-evaluated information is decomposed using the decomposition strategy, and the decomposed sample initial to-be-evaluated information is threshold-quantized using the preset threshold; and
training an initial evaluation model using the sample crack information, the sample geometric information, the sample soil information, and the sample environmental information to obtain the evaluation model meeting a preset evaluation condition.
